(19) United States
(12) Patent Application Publication
(10) Pub. No.: US 2004/0136444 A1
(43) Pub. Date: Jul. 15, 2004

(54) Cascade filter receiver for DS-CDMA communication systems

(76) Inventors: Daniel Massicotte, Trois-Rivieres (CA); Adel-Omar Dahmane, Trois-Rivieres (CA)

Correspondence Address: OGILVY RENAULT, 1981 MCGILL COLLEGE AVENUE, SUITE 1600, MONTREAL, QC, H3A2Y3, CA

(21) Appl. No.: 10/695,444

(22) Filed: Oct. 29, 2003

Related U.S. Application Data
(60) Provisional application No. 60/421,806, filed on Oct. 29, 2002.

(51) Int. Cl. H04B 1/707; H04K 1/00

(52) U.S. Cl. 375/147; 375/350

(57) ABSTRACT

A description of an adaptable multiuser processing unit applied to Direct-sequence Code Division Multiple Access (DS-CDMA) is disclosed. The adaptable multiuser processing unit consists of cascade filters where each filter is adapted independently. The adaptation of a first filter is based on the error between the output of the first filter and a desired signal, in the same way for the other filters. The adaptation is realized follow a direct, without channel identification, or indirect, with channel identification, procedure. The first filter receives the input signal in Baud (1/T) or Fractionally (k/T) spaced and the last filter gives to the MUD output the decisions on the symbols estimated for each users. A decision feedback may be applied to the input of each filter such as the conventional Decision Feedback Equalizer (DFE). In more, each filter can be linear or nonlinear.

### TECHNICAL FIELD

This invention pertains to the field of digital telecommunications. More precisely, this invention relates to channel equalization systems.

### BACKGROUND OF THE INVENTION

Channel equalization is one of the fundamental problems in digital telecommunications.

Now referring to FIG. 1, there is shown a model of communication system which indicates the position of the equalization/detection techniques in a communication system.

Unlike TDMA (Time Division Multiple Access) equalizers, DS-CDMA (Direct-Sequence Code Division Multiple Access) equalizers consist in removing intersymbol interference (ISI) from data received through a telecommunication channel as well as Multiple Access Interference (MAI).

Now referring to FIG. 2, there is shown a baseband model for DS-CDMA. In this model, K users are transmitting symbols from the alphabet Ξ={−1,1}. The skilled addressee will appreciate that the model may be extended to complex symbols with arbitrary power.

Each symbol originating from a user is spread using a pseudo-noise (PN) sequence of length N_{c}. The pseudo-noise sequence might be generated by combining orthogonal variable spreading factor codes with scrambling.

A symbol period is denoted by T and a chip period is denoted by T_{c}, where N_{c}=T/T_{c}. All users are assumed to use the same chip pulse shaping filter, denoted by ψ(t) which is the raised cosine with roll off factor β=0.22, for 3GGP standard. All channels, including any attenuation in the k^{th} user's transmission path, are multipath Rayleigh fading with Lₖ paths, denoted by h(t), with maximum delay spread τₘ.

Baud spaced indexes are represented by n and chip spaced indexes are represented by m. User k's n^{th} symbol is denoted by bₖ⁽ⁿ⁾. The model used is in Baud spaced and for synchronous DS-CDMA but may be easily extended to fractionally spaced and asynchronous as will note someone skilled in the art.

The expression of the k^{th} user's continuous time spreading waveform is denoted

$${s}_{k}^{( n )} ( t ) = {\sum }_{m = 0}^{{N}_{c} - 1} {s}_{k , m}^{( n )} ψ ( t - m {T}_{c} ) . \qquad ( Equation 1 )$$

The complex envelop of the received signal is

$$\tilde{r} ( t ) = {\sum }_{n - 0}^{{N}_{b} - 1} {\sum }_{k = 1}^{K} {A}_{k} {b}_{k}^{( n )} {s}_{k}^{( n )} ( t - n T ) * {h}_{k}^{( n )} ( t ) + η ( t ) , \qquad ( Equation 2 )$$

where N_{b} represents the number of received symbols, Aₖ the received amplitude of user k, η(l) the additive Gaussian noise with variance σ_{η}² and * represents linear convolution. The transmission channel hₖ(l) for user k is defined by

$${h}_{k}^{( n )} ( t ) = {\sum }_{l = 1}^{{L}_{k}} {h}_{k , l}^{( n )} δ ( t - {τ}_{k , l} ) , \qquad ( Equation 3 )$$

where Lₖ is the number of propagation paths, h_{k,l}⁽ⁿ⁾ the complex gain of the path l for user k at time n, τₖⱼ is the propagation delay and δ(t) is the Dirac pulse. The received signal can then be written as

$$\tilde{r} ( t ) = {\sum }_{n = 0}^{{N}_{b} - 1} {\sum }_{k = 1}^{K} {A}_{k} {b}_{k}^{( n )} {\sum }_{l = 1}^{L} {h}_{k , l}^{( n )} {s}_{k}^{( n )} ( t - n T - {τ}_{k , l} ) + η ( t ) . \qquad ( Equation 4 )$$

The discrete form of the last equation, in Baud spaced, is \tilde{r}=SHAb+η (Equation 5), where \tilde{r}=[\tilde{r}⁽⁰⁾^{^{T}}, . . . , \tilde{r}^{(N}^{_{b}}⁻¹⁾^{^{T}}]^{T} (Equation 6).

\tilde{r}⁽ⁿ⁾=[\tilde{r}(T_{c}(nN_{c}1+)), . . . , \tilde{r}(T_{c}(n+1)N_{c})]

and S=[S⁽⁰⁾, . . . , S^{(N}^{_{b}}⁻¹⁾] (Equation 7)

$${S}^{( n )} = [ \begin{matrix}{s}_{1 , 1}^{( n )} & ⋯ & {s}_{1 , L}^{( n )} & ⋯ & {s}_{K , L}^{( n )}\end{matrix} ] \qquad ( Equation 8 )$$

S represents the matrix of pseudo-noise sampled sequences where

$$D = ⌈ \frac{T + {T}_{m}}{T} ⌉ .$$

The channel matrix is H=diag[H⁽⁰⁾, . . . , H^{(N}^{_{b}}⁻¹⁾],

$${H}^{( n )} = diag [ \begin{matrix}{h}_{1}^{( n )} & ⋯ & {h}_{K}^{( n )}\end{matrix} ] ,$$

$${h}_{k}^{( n )} = {[ \begin{matrix}{h}_{k , 1}^{( n )} & ⋯ & {h}_{k , L}^{( n )}\end{matrix} ]}^{T} . \qquad ( Equation 9 )$$

The matrix of signal amplitudes is A=diag[A⁽⁰⁾, . . . , A^{(N}^{_{b}}^{-1)], A}⁽ⁿ⁾=diag[A₁, . . . , A_{K}] (Equation 10)

and finally, the transmitted symbols are b=[b⁽⁰⁾^{^{T}}, . . . , b^{(N}^{_{b}}⁻¹⁾^{^{T}}]^{T},

$${b}^{( n )} = {[ \begin{matrix}{b}_{1}^{( n )} & , ⋯ , & {b}_{K}^{( n )}\end{matrix} ]}^{T} . \qquad ( Equation 11 )$$

Various algorithms have been developed in order to solve the problem of obtaining the estimate \hat{b}ₖ⁽ⁿ⁾ of the original sequence bₖ⁽ⁿ⁾ on the basis of \tilde{r}^{(m)}.

Most of the algorithms developed may be reduced to digital filtering of the sequence of symbols corrupted by inter-symbol interference and multiple access interference:

\hat{b}ₖ⁽ⁿ⁾=F[\tilde{r}⁽ⁿ⁾] (Equation 12).

In order to have a discrete linear model, a filter of N_{f} dimension must be considered. The filter will be applied to the output of the model.

In order to do so, the vector \tilde{r}⁽ⁿ⁾=[\tilde{r}^{(m)}, \tilde{r}^{(m-1)}, . . . , \tilde{r}^{(m-N}^{_{f}}⁺¹⁾]^{T} (Equation 13) is introduced.

A first receiver, proposed for IS-95, is the Rake receiver in order to take advantage of the fading nature of the channel. However, the near-far problem and presence of multiple access interference made the receiver inefficient (Holma H., et Toskala A., WCDMA for UMTS: Radio Access For Third Generation Mobile Communications, John Wiley & Sons LTD, 2000).

Optimal receivers have been disclosed in order to overcome the interferences. They were considered mostly to extend the use of TDMA equalizers to DS-CDMA ones. Those algorithms are the Maximum Likelihood Sequence Estimation (MLSE) algorithm for sequence detection and the Maximum a-posteriori (MAP) algorithm for symbol-by-symbol detection.

Unfortunately, these algorithms are unpractical since complexity grows exponentially with the number of users (Verdù S., MULTIUSER DETECTION, Cambridge University Press, 1998). Other algorithms proposed are the ZF (Zero Forcing) algorithm and the MMSE (Minimum Mean Square Error) algorithm which require the exact impulse response of all the users channels (Verdù S., MULTIUSER DETECTION, Cambridge University Press, 1998 and Klein S., Kaleh G. K., et Baier P. W., “Zero Forcing and Minimum Mean-Square-Error Equalization for Multiuser Detection in Code-Division Multiple-Access Channels”, IEEE Transactions on Vehicular Technology, Vol. 45, No. 2, Mai 1996, pp. 276-287). This is unpractical.

PIC (Parallel Interference Cancellation) and SIC (Successive Interference Cancellation) may also be introduced. The optimal version of these two receivers is very sensitive to the knowledge of the channel parameters (taps and delays). Since this is hard to obtain, it is difficult to remove the multiple access interferences (Verdù S., Multiuser detection, Cambridge University Press, 1998).

Other receivers were proposed based on nonlinear filters (e.g. neural networks) without the achievement of one general structure to equalize and detect all the users (Das K., et Morgera S. D., “Adaptive Interference Cancellation for DS-CDMA Systems Using Neural Network Techniques”, IEEE Journal on Selected Areas in Communications, Vol. 16, No. 9, 1998, pp. 1774-1784).

It is therefore an object of the invention to overcome the above-mentioned drawbacks.

### SUMMARY OF THE INVENTION

It is an object of the invention to provide a multiuser detection unit.

Yet another object of the invention is to provide a method for performing a multiuser detection in a CDMA receiver.

According to one aspect of the invention, there is provided an adaptable multiuser processing unit providing a plurality of estimated user signals for each user communication signal of a transmitted communication channel signal in a multi-access network, comprising a processor receiving the transmitted communication channel signal and providing the plurality of estimated user signals in accordance with control parameters being modified by an error feedback signal having a plurality of components, each of the plurality of components being related to the estimated user signal and a feedback unit receiving and comparing the plurality of estimated user signals for each user and providing the error feedback signal to the processor.

### BRIEF DESCRIPTION OF THE DRAWINGS

Further features and advantages of the present invention will become apparent from the following detailed description, taken in combination with the appended drawings, in which:

FIG. 1 is a block diagram which shows a model of a communication system incorporating an apparatus in accordance with an embodiment of the invention;

FIG. 2 is a block diagram which shows a baseband model of the DS-CDMA system incorporating an apparatus in accordance with an embodiment of the invention;

FIG. 3a and FIG. 3b are block diagrams which show an adaptable multiuser processing unit for DS-CDMA systems in accordance with one embodiment of the invention;

FIG. 4 is a block diagram which shows another embodiment of an adaptable multiuser processing unit for DS-CDMA systems comprising a cascade filter structure:

FIG. 5a is a block diagram which shows an adaptable multiuser processing unit comprising an equalizer filter;

FIG. 5b is a block diagram which shows an equalizer filter for a user k and its decision feedback signal;

FIG. 6a is a block diagram which shows an adaptable multiuser processing unit comprising a signature filter;

FIG. 6b is a block diagram which shows a signature filter for a user k and its error feedback signal;

FIG. 7 is a block diagram which shows a symbol detection unit;

FIG. 8a is a block diagram which shows another embodiment of a symbol detection unit;

FIG. 8b is a block diagram which shows a symbol detection unit of user k and its error feedback signal;

FIG. 9a is a block diagram which shows a blind adaptation using an equalizer filter and its error feedback signal;

FIG. 9b is a block diagram which shows a blind adaptation using a signature filter and its error feedback signal;

FIG. 9c is a block diagram which shows a blind adaptation using a symbol detector of user k and its error feedback signal;

FIG. 10 is a block diagram which shows a structure of the nonlinear filter which may be used for at least one of an equalizer filter, a signature filter and a symbol detection unit;

FIG. 11a is a block diagram which shows a first embodiment of a fractionally-spaced adaptable multiuser processing unit for CDMA;

FIG. 11b is a block diagram which shows a second embodiment of a fractionally-spaced adaptable multiuser processing unit for CDMA;

FIG. 11c is a block diagram which shows a third embodiment of a fractionally-spaced adaptable multiuser processing unit for CDMA;

FIG. 11d is a block diagram which shows a fourth embodiment of a fractionally-spaced adaptable multiuser processing unit for CDMA; and

FIG. 11e is a block diagram which shows a fifth embodiment of a fractionally-spaced adaptable multiuser processing unit for CDMA.

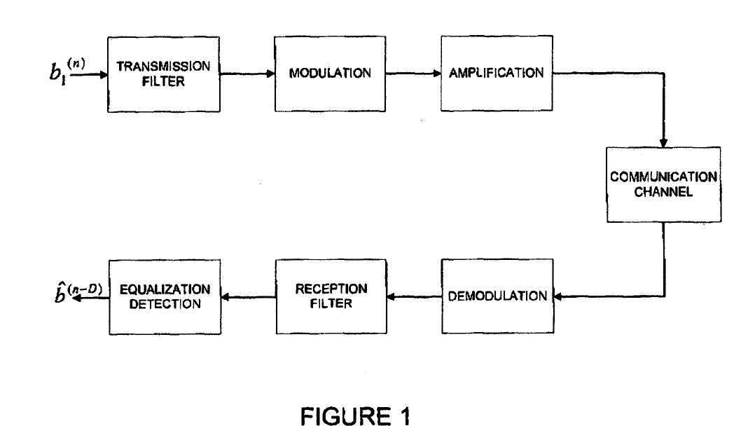

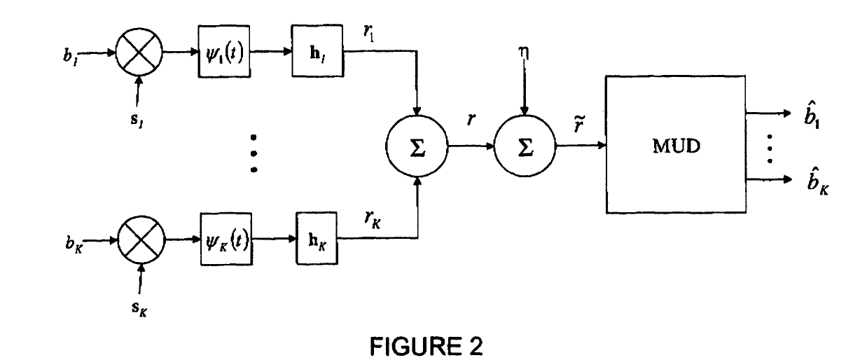

It will be noted that throughout the appended drawings, like features are identified by like reference numerals.

### DETAILED DESCRIPTION OF THE PREFERRED EMBODIMENT

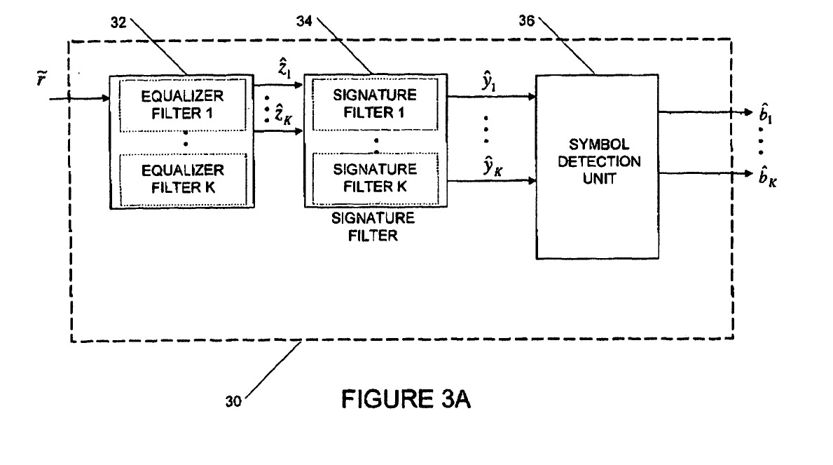

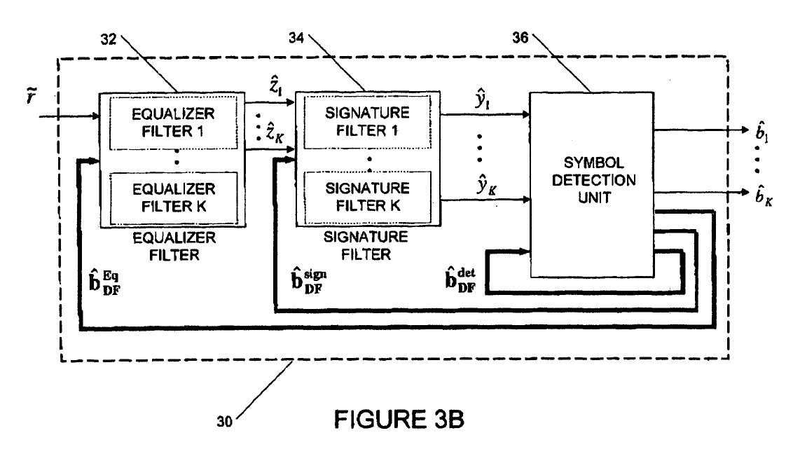

Now referring to FIG. 3a and FIG. 3b, there are shown an adaptable multiuser processing unit in accordance with the preferred embodiment of the invention.

The adaptable multiuser processing unit 30 comprises a first filter unit 32, a second filter unit 34 and a symbol detection unit 36.

In the preferred embodiment, the first filter unit 32 is an equalizer filter, while the second filter unit 34 is a signature filter.

The purpose of the first filter unit 32 is to attenuate the inter-symbol interferences (ISI). The purpose of the second filter unit 34 is to attenuate both the inter-symbol interferences and the multiple-access interferences. The purpose of the symbol detection unit 36 is to make a decision on the symbols ŷ₁, . . . , ŷₖ received for each user and to suppress a residual multiple-access interference.

It will be appreciated by the one skilled in the art that the adaptable multiuser processing unit 30 enables a fast convergence speed.

Furthermore, it will be appreciated that the combination of the first filter unit 32, the second filter unit 34 and the symbol detection unit 36 enables an innovative approach of multiuser detection. In fact, the input of the symbol detection unit 36 sees the output of the second filter unit 34 providing its signal at a symbol rate speed. Other details of FIG. 3a and FIG. 3b are described herein below.

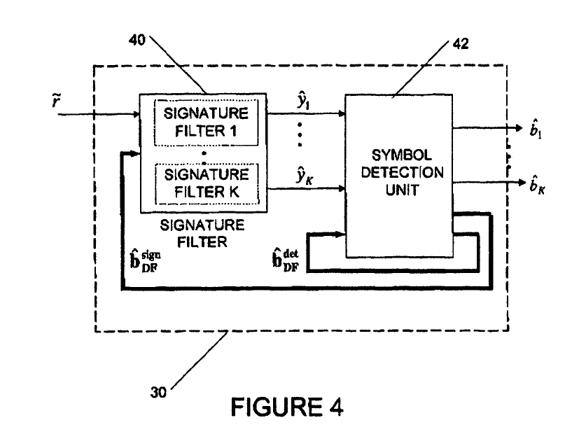

Now referring to FIG. 4, there is shown an alternative embodiment of the adaptable multiuser processing unit 30. In this alternative embodiment, the adaptable multiuser processing unit 30 comprises a signature filter 40 and a symbol detection unit 42.

Description of the Equalization Filter

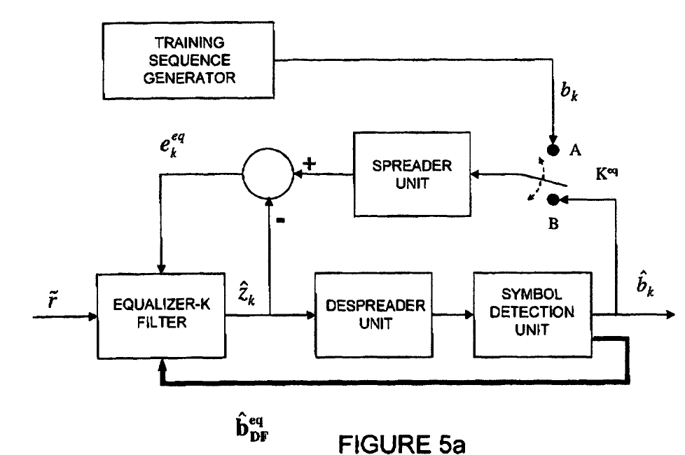

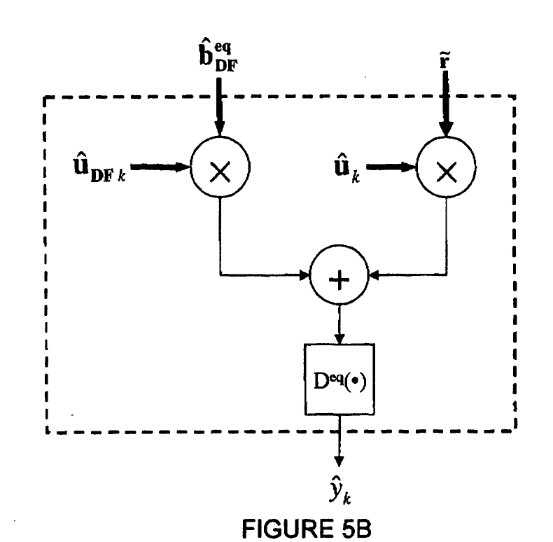

Now referring to FIG. 5a, there is shown an equalizer filter operating at a chip rate (1/Tc) and providing an output \hat{b}ₖ at the chip rate (1/Tc).

In this embodiment, the equalizer filter is adapted for each user as in TDMA systems. A decision feedback signal is provided at the chip rate (1/T_{c}).

As shown in FIG. 5a, a despreader unit is used in order to provide the output signal of the equalizer filter at the symbol rate before applying it to the input of the symbol detection unit. The input and the output of the symbol detection unit operate at the symbol rate (1/T).

It will further be appreciated that a spreader unit is used in order to obtain an error feedback signal eₖ^{cq} at the chip rate (1/T_{c}). It will be understood that the despreader unit represents a particular case of the signature filter of FIG. 3a and FIG. 3b. In fact, the signature filter provides an adaptable procedure using the error feedback signal eₖ^{cq}.

As shown in FIG. 5b, it will be appreciated that with exception of the data chip rate through the equalizer filter, the functionality of the equalizer filter is performed in the same way that the one of the signature filter. More precisely, the functionality is achieved using the coefficients, the vector of feed forward weights and using an adaptation method and optionally the vector of feedback weights.

Description of the Signature Filter

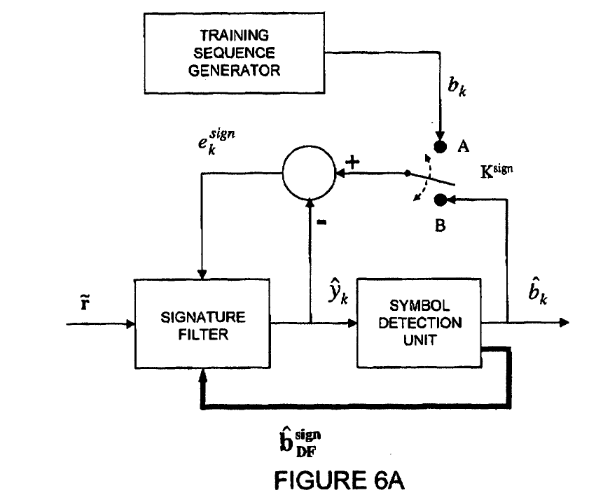

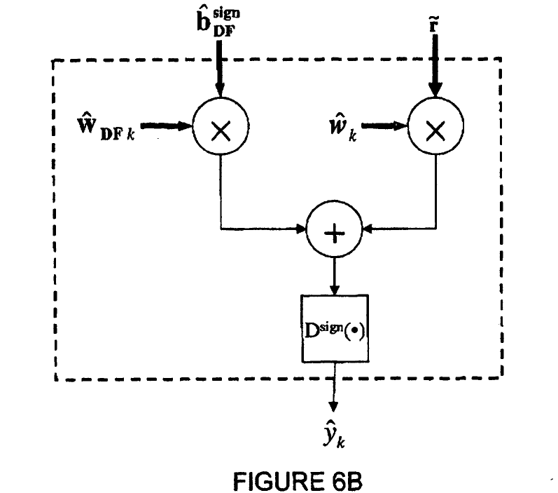

Now referring to FIG. 6b, there is shown an embodiment of the signature filter.

The idea retained for the signature filter of the receiver, and shown on FIG. 6b, is to adapt the signatures of the users without prior knowledge of their pseudo-noise codes (e.g. E. S. L. Miller, “An Adaptive Direct-Sequence Code-Division Multiple-Access Receiver for Multiuser Interference Rejection”, IEEE Transactions on Communications, Vol. 43, No. 2/3/4, 1995, pp. 1746-1755). In order to adapt the signatures of the users without prior knowledge of their pseudo-noise codes, a vector of feed forward weights, ŵₖ⁽ⁿ⁾, dim(ŵₖ⁽ⁿ⁾)=N_{f}×1 and optionally a vector of feedback weights, ŵ_{DFk}⁽ⁿ⁾_{f} dim(ŵ_{DFk}⁽ⁿ⁾)=KM_{DF}×1 are defined using an adaptation method.

It will be appreciated that many adaptation methods may be applied. For instance, the Least Mean Square (LMS) algorithm method, the Recursive Least Square (RLS) algorithm method, Kalman filtering or the like in standard or normalized versions.

In the preferred embodiment, the normalized algorithm method or the standard Least Mean Square algorithm method is used.

It will be appreciated that the adaptation method may be based on a neural network approach to apply a nonlinear method for the detection filter.

The output of the kth signature filter, shown in FIG. 6b, may be expressed as

$${\hat{y}}_{k}^{( n )} = {D}^{sign} ( {\hat{w}}_{k}^{( n ) H} {\overline{r}}^{( m )} + {\hat{w}}_{DF k}^{ ( n ) H} {\hat{b}}_{DF}^{sign ( n )} ) , \qquad ( Equation 22 )$$

where D^{sign}(o) represents the decision function specific for the signature filter.,

Exponent H refers to the Hermitian operator and the decision feedback vector is

$$\begin{matrix}{\hat{b}}_{DF}^{sign ( l )} = [ {\hat{b}}_{1}^{( n - 1 )} … {\hat{b}}_{1}^{( n - {M}_{DF} )} … \\ {\hat{b}}_{2}^{( n - 1 )} … {\hat{b}}_{2}^{( n - {M}_{DF} )} … \\ { {\hat{b}}_{K}^{( n - 1 )} … {\hat{b}}_{K}^{( n - {M}_{DF} )} ]}^{T} ,\end{matrix} \qquad ( Equation 23 )$$

with dim

$$dim ( {b}_{DF}^{sign ( R )} ) = {M}_{DF} K \times 1 ,$$

where M_{DF} represents the order of the feedback and depends on the channel and the length of the pseudo-noise sequences.

The weights may be updated by following the four equations,

$$\begin{matrix}{e}_{k}^{sign ( n )} = {b}_{k}^{( n )} - {\hat{y}}_{k}^{( n )} , & ( Equation 24 ) \\ {\hat{w}}_{Tk}^{( n )} = [ \begin{matrix}{\hat{w}}_{k}^{( n )} \\ {\hat{w}}_{DF k}^{( n )}\end{matrix} ] , dim ( {w}_{Tk}^{( n )} ) = {KM}_{DF} \times 1 , & ( Equation 25 ) \\ {\overline{r}}_{T} ( l ) = [ \begin{matrix}\overline{r} ( l ) \\ {\hat{b}}_{DF}^{sign} ( l )\end{matrix} ] , dim ( {\overline{r}}_{T} ( l ) ) = {N}_{f} \times 1 , & ( Equation 26 ) \\ {\hat{w}}_{Tk}^{( n + 1 )} = {\hat{w}}_{Tk}^{( n )} + μ \frac{{\tilde{r}}_{T}^{( l )}}{‖ {\tilde{r}}_{T}^{( l )} ‖} {e}_{k}^{{sign ( n )}^{*}} . & ( Equation 27 )\end{matrix}$$

Now referring to FIG. 6a, there is shown an embodiment of the adaptable multiuser processing unit where the signature filter disclosed in FIG. 6b is used. More precisely, and as shown, the signature filter may even be implemented in a decision directed with switch K^{sign} in position B fashion in order to follow the channel variations.

It will be noted that nonlinear function D^{sign}(o) is used to condition the output signal. However, the nonlinear function D^{sign}(o) may change in neural networks applications. It may be, for example, a sigmoid.

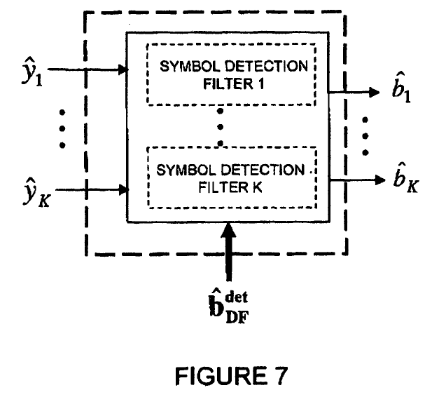

Now referring to FIG. 7, there is shown an embodiment of a symbol detection unit. The symbol detection unit comprises a plurality of symbol detection filters, each receiving a symbol, each of the plurality of symbol detection filters being specific to a user and providing, for each specific user, an estimated user signal.

Description of the Symbol Detection Filter

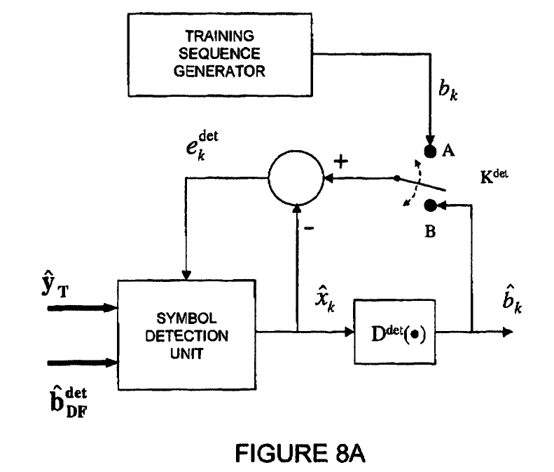

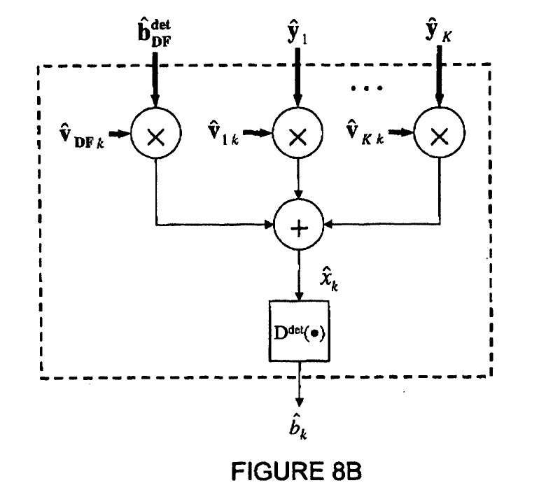

Now referring to FIG. 8b, there is shown an embodiment of a symbol detection filter structure for user k.

The purpose of the symbol detection unit is to suppress the multiple-access interference knowing the signals of all the users.

Unlike the filters located before the symbol detection unit such as the signature filter 34, which can be used in the handset part and in the base station terminals, the symbol detection unit is usually used at the base station.

The vector weights are defined as follows

$${\hat{v}}_{Tk}^{( n )} ,$$

$$dim ( {\hat{v}}_{Tk}^{( n )} ) = K ( R + {M}_{DF} ) \times 1 \text{:}$$

$${\hat{v}}_{Tk}^{( n )} = {[ {\hat{v}}_{Ik}^{{( n )}^{T}} … {\hat{v}}_{Kk}^{{( n )}^{T}} {\hat{v}}_{DFk}^{{( n )}^{T}} ]}^{T} , \qquad ( Equation 14 )$$

where

$$dim ( {\hat{v}}_{ik}^{( n )} ) = R \times I for i = 1 , 2 , … , K and dim ( {\hat{v}}_{DFk}^{( n )} ) = {M}_{DF} \times 1.$$

The output of the k^{th} symbol detection filter may be written as

$${\hat{x}}_{k}^{( n )} = {\hat{v}}_{Tk}^{( n ) H} {\hat{y}}_{T} ( n ) , \qquad ( Equation 15 )$$

where

$$\begin{matrix}{\hat{y}}_{T}^{( n )} = {[ {\hat{y}}_{l}^{{( n )}^{T}} , … , {\hat{y}}_{k}^{{( n )}^{T}} , … , {\hat{y}}_{K}^{{( n )}^{T}} , {\hat{b}}_{DF}^{{det ( n )}^{T}} ]}^{T} & ( Equation 16 ) \\ {\hat{y}}_{k}^{( n )} = {[ {\hat{y}}_{k}^{( n + \frac{R}{2} )} , … , {\hat{y}}_{k}^{( n - \frac{R}{2} + 1 )} ]}^{T} for k = 1 , 2 , … , K & ( Equation 17 ) \\ and {\hat{b}}_{DF}^{det ( n )} = {[ {\hat{b}}_{l}^{( n - 1 )} , … , {\hat{b}}_{l}^{( n - {M}_{DF} )} , … , {\hat{b}}_{K}^{( n - 1 )} , … , {\hat{b}}_{K}^{( n - {M}_{DF} )} ]}^{T} . & ( Equation 18 )\end{matrix}$$

The weights, also referred to as control parameters, are updated by following equations

$${e}_{k}^{det ( n )} = {b}_{k}^{( n )} - {\hat{x}}_{k}^{( n )} \qquad ( Equation 19 )$$

$${\hat{V}}_{Tk}^{( n + 1 )} = {\hat{V}}_{Tk}^{( n )} + μ \frac{{\hat{y}}_{T}^{( n )}}{‖ {\hat{y}}_{T}^{( n )} ‖} {e}_{k}^{det ( n ) *} \qquad ( Equation 20 )$$

and data detection becomes

$${\hat{b}}_{k}^{( n )} = {D}^{det} ( {\hat{x}}_{k}^{( n )} ) , \qquad ( Equation 21 )$$

where D^{det}(o) represents the decision function specific for the symbol detection.

As shown in FIG. 8a, a switch K^{det} is used in order to select one of position A and position B. Position A is used for providing a training sequence, while position B is for steady-state use.

Now referring back to FIG. 8b, it will be appreciated that many adaptation methods may be applied such as the Least Mean Square (LMS) algorithm method, the Recursive Least Square (RLS) algorithm method, Kalman filtering methods or the like in standard or normalized versions.

In the preferred embodiment, the normalized or standard Least Mean Square algorithm method is used. Also, the adaptation method may be based on a neural network approach in order to apply a nonlinear method for the symbol detection filter.

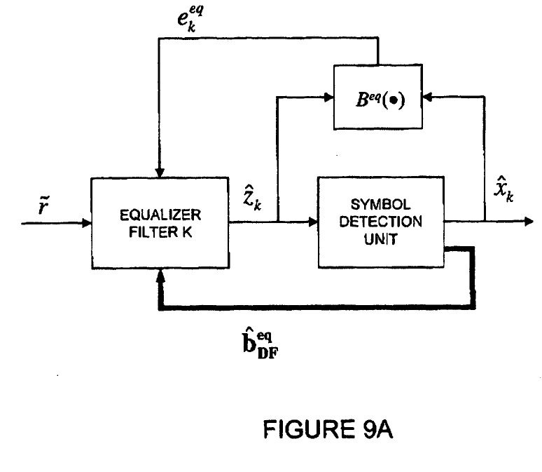

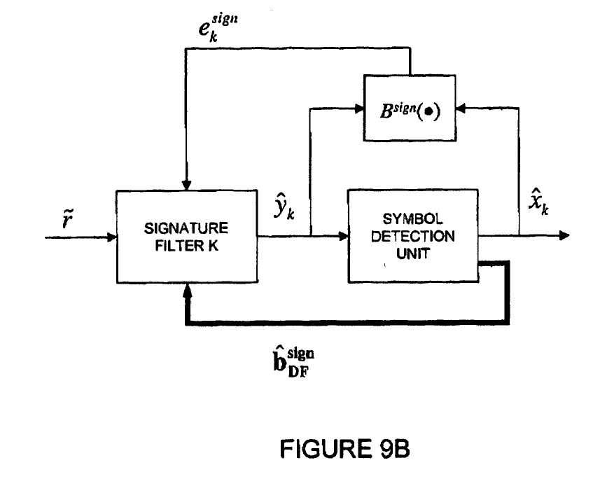

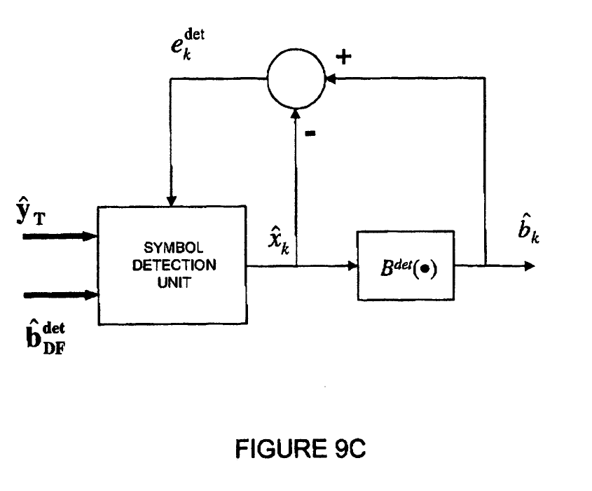

Now referring to FIG. 9a, there is shown an embodiment of a blind detection using an equalizer filter.

Now referring to FIG. 9b, there is shown an embodiment of a blind detection using a signature filter.

Now referring to FIG. 9c, there is shown an embodiment of a blind detection using a symbol detection unit.

Description of the Non-Linear Filter

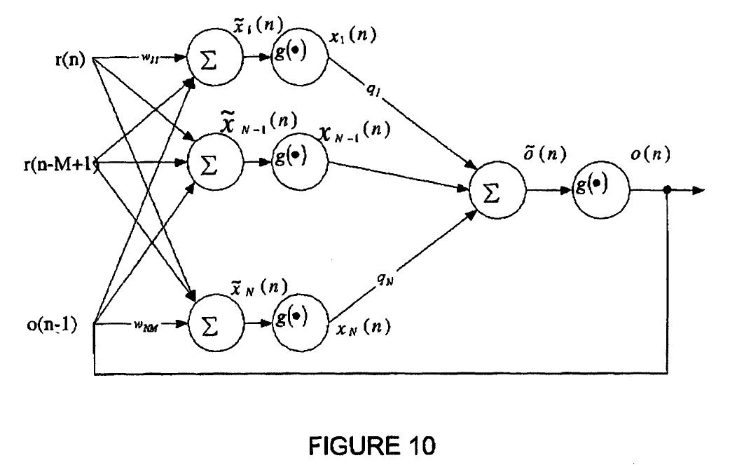

Now referring to FIG. 10, there is shown a non-linear filter unit. The non-linear filter unit may be used in order to realize at least one of the equalizer filter, the signature filter and the symbol detection unit.

In the preferred embodiment, the non-linear filter unit is based on a recursive multilayer neural network (DFNN—Decision Feedback Neural Network).

It will be appreciated that Artificial Neural Networks (ANN) are used as their adaptive property helps the receiver to track communication environment variations. Furthermore, it will be appreciated that the nonlinear decision functions help the receiver to approximate any function and the cyclostationarity of the multiple-access interferences informs the receiver to consider and remove the multiple-access interferences.

The learning algorithm is the process of adapting the connection parameters in order to minimize a loss function, given an input vector for example. The capabilities of their receiver to perform complex tasks depend on the learning rule employed to modify some features of their structures.

As known by the one skilled in the art, the most famous learning algorithm is the back-propagation algorithm, which was successfully applied to DS-CDMA systems.

The proposed nonlinear filter addresses a direct approach, i.e, the parameters of the artificial neural networks receiver have been directly adapted by using an adaptive procedure based on the error between a training data (b^{train}) and the output of the artificial neural networks or based on the error obtained following a blind procedure.

Multiuser Detection Methods

It will be appreciated that multiuser detection classification enables one to gain a valuable insight into various possibilities of algorithmic design. The multiuser detection may be linear or non-linear.

A Multiuser detection will be considered linear if a function f[o] of the equation (12) is linear in its arguments in any other case it will be considered as a non linear one.

A Multiuser detection is supervised if it is necessary to send a known sequence to estimate its coefficients (b^{train} and p^{train} for the transmit data and pilot respectively). For time-varying channels, it results in loss of available bandwidth and the adaptation can rely on a decision directed techniques corresponding to a first avenue to the Blind method. In contrast to supervised multiuser detection, blind multiuser detection estimate its coefficients without knowledge of sent sequence thus increasing the bandwidth efficiency. Examples of blind multiuser detection are shown in FIGS. 9a, 9b and 9c.

Fractionally-Spaced multiuser Detection

In order to make the considerations as general as possible, the single input-multi output (SIMO) model of telecommunication system is adopted. This incorporates two cases of oversampling which are time oversampling (fractionally-spaced receivers) and space oversampling (multiple antennas receivers) (A. Paulraj, C. B. Papadias, “Space-Time Processing for Wireless Communications”, IEEE Signal Process. Mag., November 1976, pp. 49-83).

Of course both cases may be considered simultaneously leading to time and space oversampling. The Fractionally-Spaced Equalizers (FSE) were introduced in order to reduce the timing synchronization sensibility (G. Ungerboeck “Fractional Tap-Spacing Equalizer and Consequences for Clock Recovery in Data Modems”, IEEE Trans. Comm., Vol. COM-24, August 1976, pp. 856-864) and they proved to be very effective to combat the inter-symbol interferences problem for channels with deep nulls.

The spatially oversampled equalizers are important to deal with a diversity introduced to combat fading (T. S. Rappaport, Wireless Communications: Principles and Practice, Prentice Hall 1996). The equations described above can be extended for Fractionally-Spaced Equalizers models.

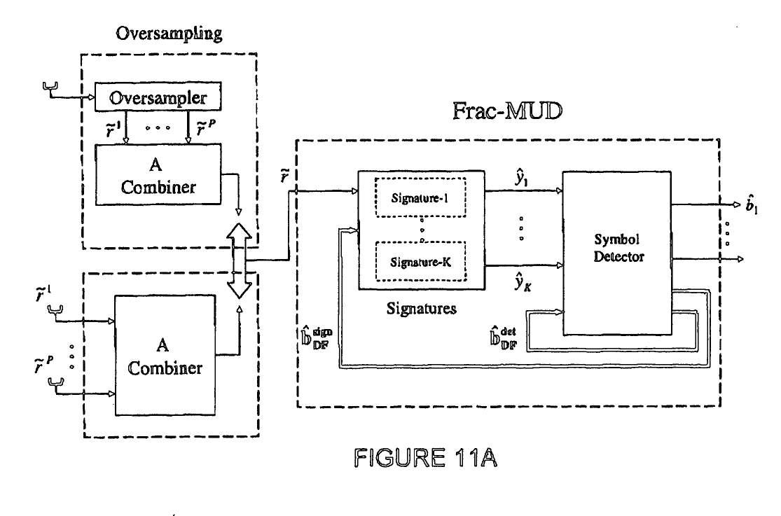

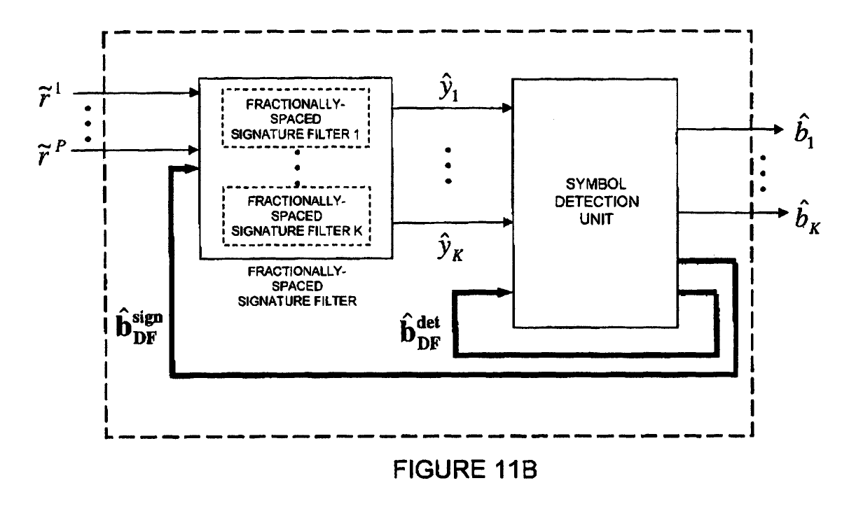

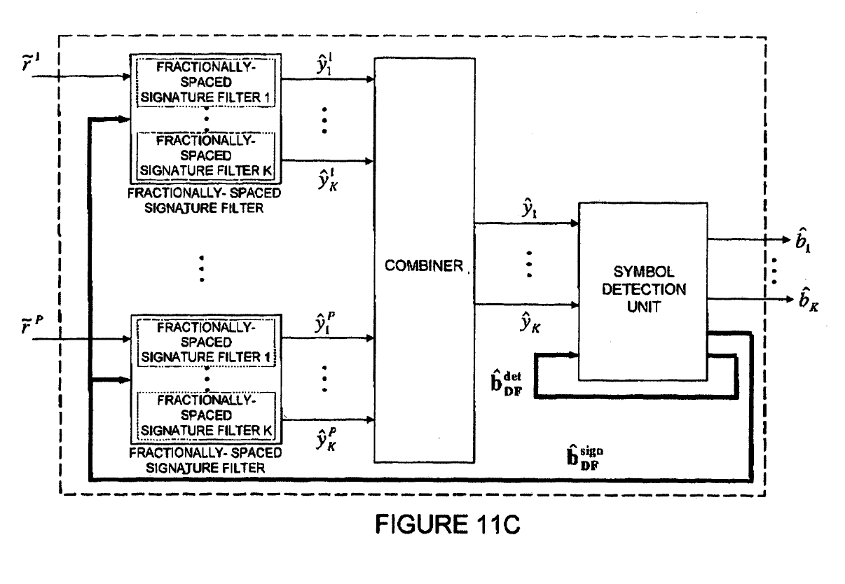

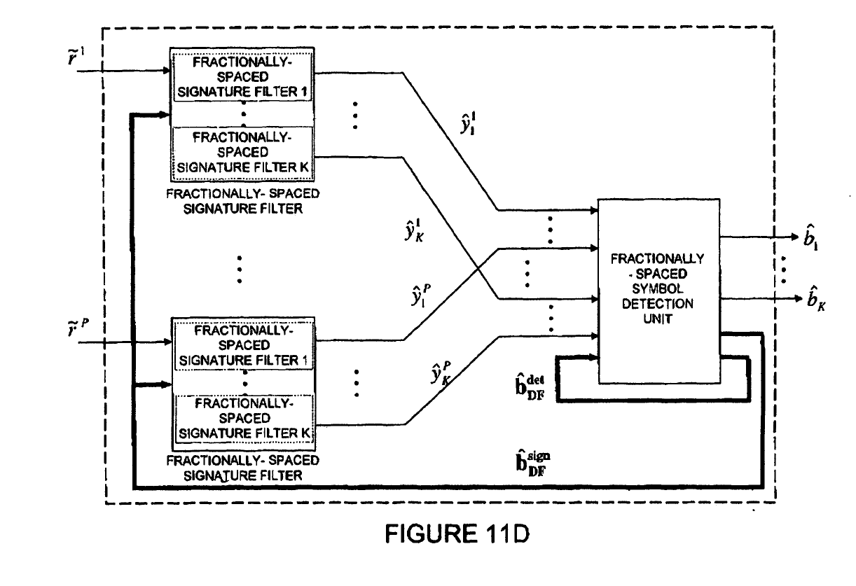

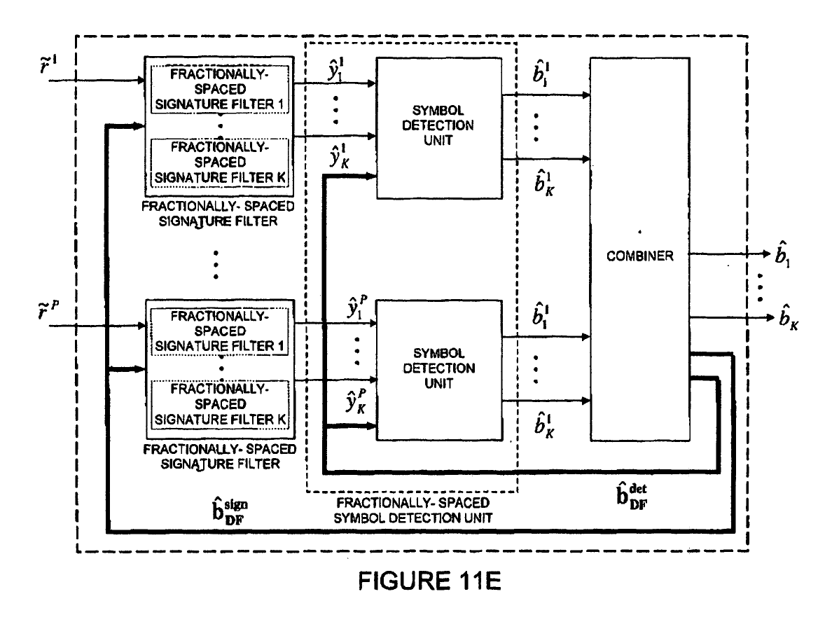

Now referring to FIGS. 11a, 11b, 11c, 11d, 11e, there are shown five embodiments of fractionally-spaced adaptable multiuser processing units for DS-CDMA.

More precisely, there is disclosed in FIG. 11a an embodiment of the adaptable multiuser processing unit where a signal \tilde{r} is oversampled by a degree “P”.

Signal \tilde{r}=C([\tilde{r}¹, \tilde{r}², . . . ,\tilde{r}^{P}]) (Equation 1) is the result of a combining function C[o] applied on an input signal oversampled by the degree “P”. It will be appreciated that either time oversampling or space oversampling is performed.

Now referring to FIG. 11b, there is shown an alternative embodiment of the adaptable multiuser processing unit where a plurality of incoming oversampled signals \tilde{r}¹, . . . , \tilde{r}^{p} are provided. In this embodiment, the adaptable multiuser processing unit comprises at least one fractionally-spaced signature filter. The at least one fractionally-spaced signature filter provides at least one estimated user signal ŷ₁, . . . , ŷₖ. The adaptable multiuser processing unit further comprises a symbol detection unit, receiving the at least one estimated user signal ŷ₁, . . . , ŷₖ and providing at least one corresponding symbol \hat{b}¹, . . . , \hat{b}ₖ for each user.

Now referring to FIG. 11c, there is shown an alternative embodiment of the adaptable multiuser processing unit where a plurality of fractionally-spaced signature filters is used. Each oversampled signal, of a plurality of incoming oversampled signals \tilde{r}¹, . . . , \tilde{r}^{p}, is provided to a corresponding signature filter. Each signature filter provides at least one estimated user signal ŷ_{I}^{J}, where I-1 to k and J=1 to P, for each user. A combiner receives the at least one estimated user signal ŷ_{I}^{J} and provides a combined estimated user signal ŷ₁, . . . , ŷₖ. The combined estimated user signal ŷ₁, . . . , ŷₖ is provided to a symbol detection unit which provides at least one corresponding symbol \hat{b}₁, . . . , \hat{b}ₖ for each user.

Now referring to FIG. 11d, there is shown an alternative embodiment of the adaptable multiuser processing unit. In this alternative embodiment, the adaptable multiuser processing unit comprises a plurality of fractionally-spaced signature filters which receives incoming oversampled signals \tilde{r}¹, . . . , \tilde{r}^{p}. A fractionally-spaced symbol detection unit receives at least one estimated user signal ŷ_{I}^{J}, where I=l to k and J=1 to P. The fractionally-spaced symbol detection unit provides at least one corresponding symbol \hat{b}₁, . . . , \hat{b}ₖ for each user.

Now referring to FIG. 11e, there is shown an embodiment of the adaptable multiuser processing unit. In this embodiment, the adaptable multiuser processing unit comprises a fractionally-spaced symbol detection unit. The fractionally-spaced symbol detection unit comprises a plurality of symbol detection units. Each symbol detection unit receives at least one estimated user signals provided by a corresponding fractionally-spaced signature filter. A combiner is further used in order to provide a combined plurality of symbols \hat{b}₁, . . . , \hat{b}ₖ for each user.

The embodiments of the invention described above are intended to be exemplary only. The scope of the invention is therefore intended to be limited solely by the scope of the appended claims.

We claim:

1. An adaptable multiuser processing unit providing a plurality of estimated user signals for each user communication signal of a transmitted communication channel signal in a multi-access network, comprising:
a processor receiving the transmitted communication channel signal and providing said plurality of estimated user signals in accordance with control parameters being modified by an error feedback signal having a plurality of components, each of the plurality of components being related to said estimated user signal; and
a feedback unit receiving and comparing the plurality of estimated user signals for each user and providing the error feedback signal to the processor.

2. The adaptable multiuser processing unit as claimed in claim 1, wherein the processor is a symbol detection unit providing a plurality of symbols, further wherein the feedback unit receives and compares the plurality of symbols for each user and provides the error feedback signal to the symbol detection unit.

3. The adaptable multiuser processing unit as claimed in claim 1, wherein said processor comprises a first filter unit receiving a transmitted communication channel signal and providing a plurality of estimated user signals, further comprising a de-spreader unit receiving the plurality of estimated user signals at the chip rate of the processor and providing a plurality of estimated symbols for each user at a given symbol rate and a symbol detection unit receiving the plurality of estimated user signals at the symbol rate and providing a plurality of estimated symbols for each user, the feedback unit receiving and comparing at least the plurality of estimated user signals at the symbol rate with the plurality of estimated symbols for each user to provide the error feedback signal at the chip rate to the first filter unit.

4 The adaptable multiuser processing unit as claimed in claim 1, wherein the processor comprises a first filter unit receiving a transmitted communication channel signal and providing a plurality of estimated user signals, further comprising a symbol detection unit receiving the plurality of estimated user signals and providing a plurality of symbols for each user, the feedback unit receiving and comparing at least the plurality of estimated user signals with the plurality of estimated symbols for each user to provide the error feedback signal to the first filter unit.

5. The adaptable multiuser processing unit as claimed in claim 3, wherein the first filter unit is an equalizer filter.

6. The adaptable multiuser processing unit as claimed in claim 4, wherein the first filter unit is a signature filter.

7. The adaptable multiuser processing unit as claimed in claim 5, wherein the feedback unit receives and compares at least the plurality of estimated user signals with a training sequence signal provided by a training sequence generator to provide the error feedback signal to the equalizer filter.

8. The adaptable multiuser processing unit as claimed in claim 6, wherein the feedback unit receives and compares at least the plurality of estimated user signals with a training sequence signal provided by a training sequence generator to provide the error feedback signal to the signature filter.

9. The adaptable multiuser processing unit as claimed in claim 2, wherein the feedback unit receives at least a training sequence signal provided by a training sequence generator and provides the error feedback signal to the symbol detection unit.

10. The adaptable multiuser processing unit as claimed in claim 3, wherein the processor further comprises a second filter unit receiving the plurality of estimated user signals and providing a plurality of filtered estimated signals for each user, further wherein the symbol detection unit receives the plurality of filtered estimated signals for each user and provides a plurality of estimated symbols for each user, the feedback unit receiving and comparing at least the plurality of symbols for each user to provide the error feedback signal to the first filter unit.

11. The adaptable multiuser processing unit as claimed in claim 4, wherein the processor further comprises a second filter unit receiving the plurality of estimated user signals and providing a plurality of filtered estimated signals for each user, further wherein the symbol detection unit receives the plurality of filtered estimated signals for each user and provides a plurality of estimated symbols for each user, the feedback unit receiving and comparing at least the plurality of symbols for each user to provide the error feedback signal to the first filter unit.

12. The adaptable multiuser processing unit as claimed in claim 10, wherein the feedback unit further provides the error feedback signal to the second filter unit.

13. The adaptable multiuser processing unit as claimed in claim 11, wherein the feedback unit further provides the error feedback signal to the second filter unit.

14. The adaptable multiuser processing unit as claimed in claim 12, wherein the first filter unit comprises an equalizer filter.

15. The adaptable multiuser processing unit as claimed in claim 13, wherein the first filter unit comprises an equalizer filter.

16. The adaptable multiuser processing unit as claimed in claim 14, wherein the second filter unit comprises a signature filter.

17. The adaptable multiuser processing unit as claimed in claim 15, wherein the second filter unit comprises a signature filter.

18. The adaptable multiuser processing unit as claimed in claim 1, wherein the processor comprises a plurality of filter units, each receiving a transmitted communication channel signal and each providing a plurality of estimated user signals to a combining unit, the combining unit providing a plurality of estimated combined user signals, further comprising a symbol detection unit receiving the plurality of estimated combined user signals and providing a plurality of symbols for each user, the feedback unit receiving and comparing at least the plurality of symbols for each user to provide the error feedback signal to each of the plurality of filter units.

19. The adaptable multiuser processing unit as claimed in claim 3, wherein the first filter unit comprises a decision feedback module receiving the plurality of estimated user signals and comprising a plurality of decision parameters for each user.

20. The adaptable multiuser processing unit as claimed in claim 4, wherein the first filter unit comprises a decision feedback module receiving the plurality of estimated user signals and comprising a plurality of decision parameters for each user.

21. The adaptable multiuser processing unit as claimed in claim 5, wherein the equalizer filter comprises a decision feedback module receiving the plurality of estimated user signals and comprising a plurality of decision parameters for each user.

22. The adaptable multiuser processing unit as claimed in claim 6, further wherein said signature filter comprises a decision feedback module receiving the plurality of estimated user signals and comprising a plurality of decision parameters for each user.

23. The adaptable multiuser processing unit as claimed in claim 10, wherein anyone of the first filter unit and of the second filter unit comprises a decision feedback module receiving the plurality of estimated user signals and comprising a plurality of decision parameters for each user.

24. The adaptable multiuser processing unit as claimed in claim 11, wherein anyone of the first filter unit and of the second filter unit comprises a decision feedback module receiving the plurality of estimated user signals and comprising a plurality of decision parameters for each user.

25. The adaptable multiuser processing unit as claimed in claim 12, wherein any one of the first filter unit and of the second filter unit comprises a decision feedback module receiving the plurality of estimated user signals and comprising a plurality of decision parameters for each user.

26. The adaptable multiuser processing unit as claimed in claim 13, wherein any one of the first filter unit and of the second filter unit comprises a decision feedback module receiving the plurality of estimated user signals and comprising a plurality of decision parameters for each user.

27. The adaptable multiuser processing unit as claimed in claim 22, further wherein said symbol detection unit further comprises a decision feedback module receiving the plurality of symbols for each user and comprising a plurality of decision parameters for each user.

28. The adaptable multiuser processing unit as claimed in claim 27, wherein the signature filter comprises at least one fractionally-spaced signature filter.

29. The adaptable multiuser processing unit as claimed in claim 27, further comprising a combiner receiving a plurality of transmitted communication signals and providing a combined transmitted communication signal to said signature filter.

30. The adaptable multiuser processing unit as claimed in claim 27, further comprising an oversampling unit comprising an oversampler and a combiner, said oversampler receiving the transmitted communication signal and providing a plurality of oversampled communication signals to the combiner, the combiner further providing a combined transmitted communication signal to said signature filter.

31. The adaptable multiuser processing unit as claimed in claim 18, wherein each of the plurality of filter units is a fractionally-spaced signature filter, further wherein said symbol detection unit further comprises a decision feedback module receiving the plurality of symbols for each user and comprising a plurality of decision parameters for each user, further wherein each of said fractionally-spaced signature filter comprises a decision feedback module receiving the plurality of estimated user signals and comprising a plurality of decision parameters for each user.

32. The adaptable multiuser processing unit as claimed in claim 27, wherein the signature filter comprises a plurality of fractionally-spaced signature filters each providing a plurality of estimated user signals, further wherein the symbol detection unit comprises a fractionally-spaced symbol detection unit receiving the plurality of estimated user signals provided by each of the plurality of fractionally-spaced signature filters.

33. The adaptable multiuser processing unit as claimed in claim 32, wherein the fractionally-spaced symbol detection unit comprises a plurality of fractionally-spaced symbol detection units, each of the plurality of fractionally-spaced symbol detection units receiving the plurality of estimated user signals from each of the plurality of fractionally-spaced signature filters, further comprising a combiner receiving the plurality of symbols for each user from each of the plurality of fractionally-spaced symbol detection units, the combiner providing a combined plurality of symbol for each user.
